(19) United States
(12) Patent Application Publication
(10) Pub. No.: US 2017/0262931 A1
(43) Pub. Date: Sep. 14, 2017

(54) Methods, Systems and Computer Program Products for Providing a Recipe Service and Related Devices and Computer Program Products

(71) Applicant: Myxx, Inc., Cary, NC (US)

(72) Inventors: Monica Claire McInerney Wood, Cary, NC (US); Deirdre Houston, Cary, NC (US); Stuart Ray Allen, II, Apex, NC (US)

(21) Appl. No.: 15/457,161

(22) Filed: Mar. 13, 2017

Related U.S. Application Data
(60) Provisional application No. 62/306,813, filed on Mar. 11, 2016.

(51) Int. Cl. G06Q 30/06; G06Q 10/08; G06Q 10/10

(52) U.S. Cl. CPC G06Q 30/0635; G06Q 10/1097; G06Q 10/083

(57) ABSTRACT

Methods of providing a recipe service are provided. The method is associated with a server including a processor therein, the processor is configured to receive input from a user, the input being associated with a recipe; customize a list of items defining the recipe based on parameters associated with the user and/or input received from the user in real time; automatically populate a shopping list with the customized list of items defining the recipe for purchase by the user; modify the shopping list responsive to user input; and provide the modified shopping list for use by the user to purchase the items on the modified shopping list. Related devices and computer program products are provided.

### CLAIM OF PRIORITY

The present application claims priority to U.S. Provisional Application No. 62/306,813, filed Mar. 11, 2016 entitled Methods, Systems and Computer Program Products for Manipulating Electronic Environments and Related Purchases Thereof, the contents of which is hereby incorporated herein by reference as if set forth in its entirety.

### FIELD

The present inventive concept relates to online content and commerce and, more particularly, to methods, systems and computer program products for manipulating and customizing online content.

### BACKGROUND

Online content and commerce associated therewith is becoming more and more popular every day. More and more people are shopping online versus actually entering physical stores. Purchasing one item online can be relatively simple. However, purchasing multiple items that coordinate in some way is not as simple. Furthermore, there is no cohesive way to manipulate, share and purchase groups of items in a seamless way available to consumers.

### SUMMARY

Some embodiments of the present inventive concept provide a method of providing a recipe service. The method is associated with a server including a processor therein. The processor is configured to receive input from a user, the input being associated with a recipe; customize a list of items defining the recipe based on parameters associated with the user and/or input received from the user in real time; automatically populate a shopping list with the customized list of items defining the recipe for purchase by the user; modify the shopping list responsive to user input; and provide the modified shopping list for use by the user to purchase the items on the modified shopping list.

In further embodiments, the processor may be further configured to provide a cost associated with the modified shopping list for each of a plurality of different providers of the items on the modified shopping list; and receive a selection of one of the plurality of different providers of the items from the user before purchase of the items on the modified shopping list by the user.

In still further embodiments, the processor may be further configured to receive one of a purchase command from the user indicating that the user wants to purchase all the items on the modified shopping list and a print command from the user indicating that the user wants to print the modified shopping list. If the purchase command is received, the purchased list of items can be scheduled for one of delivery to the user and pick up by the user if the purchase command is received.

In some embodiments, the processor may be further configured to provide at least one of an estimated delivery time associated with the purchased list of items on the modified shopping list and a real time map of a current position of the purchased list of items.

In further embodiments, the processor may be further configured to share one of the recipe; the modified shopping list; a picture of a completed recipe and a reaction to the recipe on a social media platform.

In still further embodiments, the recipe may be associated with one of food, interior design, beverages, alcoholic beverages and clothing ensembles.

In some embodiments, the user may be one of a subscriber of a recipe service and a guest of the recipe service.

In further embodiments, when the user is a subscriber of the recipe service, the processor may be further configured to receive and store preferences associated with the subscriber based on at least one of cost; brand; allergies and taste.

In still further embodiments, when the user is a subscriber the processor may be further configured to store the shopping list in a virtual pantry associated with the subscriber and automatically update the pantry as items are purchased or responsive to input by the subscriber.

In some embodiments, the processor may be further configured to modify shopping list by at least one of adding items to the list; deleting items from the list; changing brands of items on the list and selecting a similar item that is priced differently than the item on the list.

In further embodiments, the processor may be further configured to prompt the user with options to add additional items to the shopping list.

In still further embodiments, the processor may be further configured to provide a reward to a partner associated with the recipe responsive to the input associated with the recipe from the user.

In some embodiments, the processor may be further configured to provide an indication of difficulty of the recipe by altering an icon on a display associated with the server.

In further embodiments, the processor may be configured to receive input from the user associated with a recipe by one of receiving a link to a recipe located on a server remote from the server including the processor and receiving a selection of a recipe located on the server including the processor.

### BRIEF DESCRIPTION OF THE DRAWINGS

FIG. 1 is a diagram illustrating the grouping of various online features according to some embodiments of the present inventive concept.

FIGS. 2A through 2D are screen shots illustrating various embodiments of the present inventive concept.

FIG. 3 is a flowchart illustrating operations according to some embodiments of the present inventive concept.

FIG. 4 is an example login screen in accordance with some embodiments of the present inventive concept.

FIGS. 5A and 5B are screen shots illustrating steps in accessing a recipe in accordance with various embodiments of the present inventive concept.

FIGS. 6A through 6C are screen shots illustrating a recipe transfer in accordance with embodiments of the present inventive concept.

FIG. 7 is a screen shot illustrating a recipe feed in accordance with some embodiments of the present inventive concept.

FIG. 8 is a screen shot illustrating a recipe in accordance with some embodiments of the present inventive concept.

FIGS. 9A and 9B are screen shots illustrating a Chef's profile in accordance with some embodiments of the present inventive concept.

FIG. 10 is a screen shot illustrating a shopping list in accordance with some embodiments of the present inventive concept.

FIG. 11 is a screen shot illustrating a “thank you” screen in accordance with some embodiments of the present inventive concept.

FIGS. 12A through 12F are various screen shots illustrating a summary of processes in accordance with some embodiments of the present inventive concept.

FIGS. 13A and 13B are screen shots illustrating sharing information via other formats in accordance with some embodiments of the present inventive concept.

FIG. 14 is an example data processing system that may be used in accordance with some embodiments discussed herein.

### DETAILED DESCRIPTION OF EMBODIMENTS

The present inventive concept will be described more fully hereinafter with reference to the accompanying figures, in which embodiments of the inventive concept are shown. This inventive concept may, however, be embodied in many alternate forms and should not be construed as limited to the embodiments set forth herein.

Accordingly, while the inventive concept is susceptible to various modifications and alternative forms, specific embodiments thereof are shown by way of example in the drawings and will herein be described in detail. It should be understood, however, that there is no intent to limit the inventive concept to the particular forms disclosed, but on the contrary, the inventive concept is to cover all modifications, equivalents, and alternatives falling within the spirit and scope of the inventive concept as defined by the claims. Like numbers refer to like elements throughout the description of the figures.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which this inventive concept belongs. It will be further understood that terms used herein should be interpreted as having a meaning that is consistent with their meaning in the context of this specification and the relevant art and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

As discussed above, currently, online content and commerce are separated, and there is no method to purchase desired items, much less share this experience with others. For example, if you encounter a great picture of cookies on Pinterest and you would like to make these cookies. To execute, you would have to navigate to the recipe site, make a list of all the ingredients, go to the store to buy the ingredients, follow the instructions, possibly search online with respect to questions that arise during the process, and then navigate to different social networks to share results with your friends. At each point in this process users are forced to utilize separate companies to identify, purchase, and share.

Accordingly, some embodiments of the present inventive concept provide value to users by connecting the various pieces of the process. Using the example above, embodiments of the present inventive concept may enable users to identify a recipe, create a list of ingredients, order the ingredients, share recipes and the like in just a few clicks, and have ingredients and related items delivered to the door. Embodiments of the present inventive concept may make a user's life easier and may be fun to use.

In some embodiments, a forum may be provided for user generated content to be capitalized upon by those generating the content. For example, with every purchase of a “recipe” the creator of the recipe may be paid an affiliate fee. Although embodiments of the present inventive concept are discussed herein with respect to food related “recipes,” it will be understood that embodiments of the present inventive concept are not limited thereto. For example, embodiments of the present inventive concept may be applied to interior design, cocktails and alcoholic beverages, clothing ensembles, and any other consumer facing product, i.e. any product available to consumers in any venue. In other words, the “recipes” are not limited to recipes for food items, but could include recipes for furniture, clothing, beverages and the like. Thus, as used herein “recipe” refers to any combination of things that would intuitively work together as a unit.

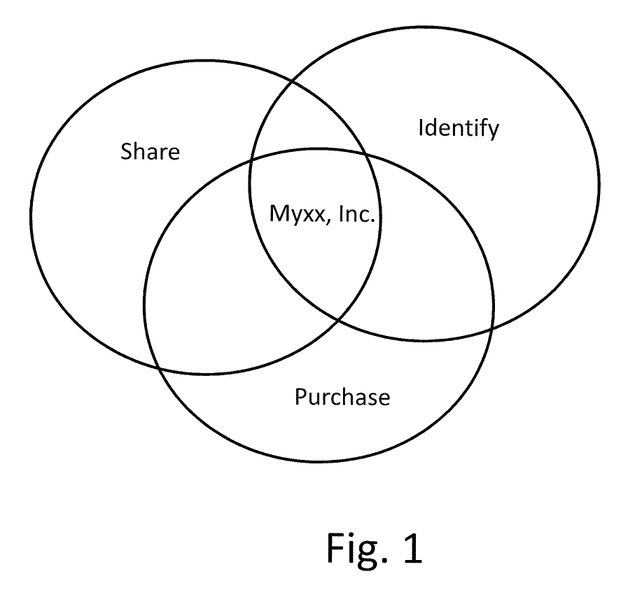

Embodiments of the present inventive concept provide methods, systems and computer program products that may enable never, or hardly ever, having to go to the grocery store again, and having everything you need to cook delivered to your door when you need it. Embodiments of the present inventive concept may provide a solution that knows what you like to eat and anticipates your needs and desires for you, and allows you to share your experience with friends and family as will be discussed below with respect to FIGS. 1 through 14.

Although some embodiments of the present inventive concept are directed to the virtual experience, embodiments of the present inventive concept are not limited thereto. In some embodiments, a shopping list may be created from the recipe(s). This shopping list may include information about the items on the list as well as location information in the store itself For example, peanut butter may be found in aisle three at Harris Teeter and aisle six at Lowes Foods. Thus, the user may simply print the shopping list generated using embodiments of the present inventive concept and use that shopping list to expedite physical (offline) shopping at the store.

Accordingly, embodiments of the present inventive concept discussed herein may be used online and/or offline to improve overall user experience. For example, the shopping list created can be used in a store or sent to a retailer of choice for curb side pickup, or delivery. The shopping list may include location information in the store (aisles) related to the products to make location of these products easier. The shopping list may be printed, emailed, texted, shared etc. and, thus, can be worked on collaboratively with your group of users.

Referring first to FIG. 1, a diagram illustrating an overview of embodiments of the present inventive concept provided by Myxx, Inc. will be discussed. The term “myxx” or “myxxed” will be used to represent the idea that items can be changed within an existing “recipe” to personalize the recipe as will be discussed further herein. As illustrated in FIG. 1, embodiments of the present inventive concept may allow users to identify a “recipe” of items they are interested in, manipulate and customize the recipe to their own wants and needs, purchase items associated therewith and share information related thereto. Thus, embodiments of the present inventive concept allow users to identify recipes, buy associated items, ingredients and/or tools and possibly have them delivered and share the experience with others (friends) via a global social commerce platform. Thus, embodiments of the present invention may enhance online shopping to seamlessly coordinate with the modern lifestyle having dynamic tastes, but may also enhance in store shopping experiences.

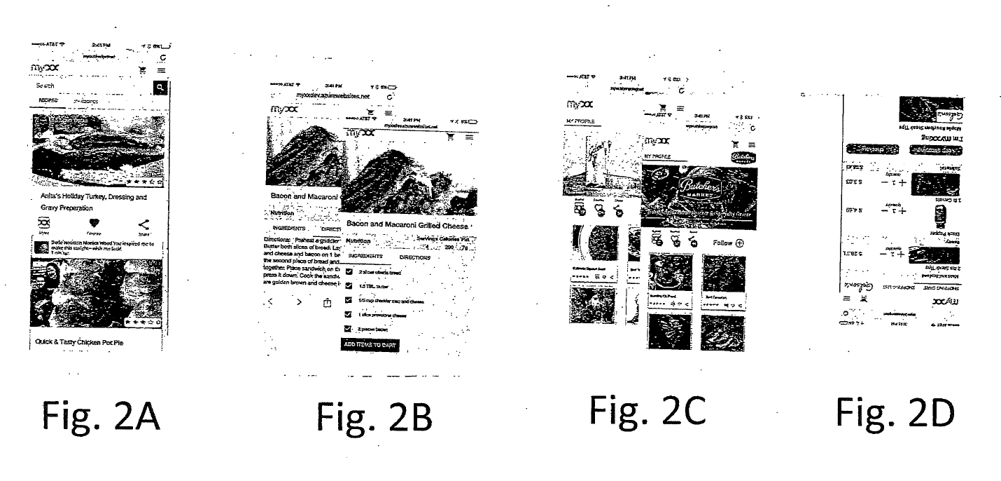

Example embodiments of the present inventive concept will now be discussed with respect to the screen shots of FIGS. 2A through 2D. A user may locate a recipe, for example, a turkey dressing recipe as illustrated in FIG. 2A. Once located, the user may manipulate the recipe (“Myxx” it) to add and/or subtract items associated therewith. If the recipe is associated with a particular partner, for example, a chef in this embodiment, the user may have the opportunity to follow the partner or brands of items included in the recipe as illustrated in FIG. 2B. As used herein, a “partner” refers to a person or company that allows use of their recipes in accordance with embodiments discussed herein. For example, a “partner” may be, for example, a chef, an interior designer, a stylist, a bartender and the like. As will be discussed further herein, in some embodiments, the partner may be paid each time a user or a threshold number of users access and purchase their recipes. This may encourage more partners to make their recipes available in accordance with embodiments discussed herein.

It will be understood that a partner is not necessarily a professional. Anyone can make their recipes available to other users without departing from the scope of the present inventive concept.

Referring now to FIG. 2C, once a recipe is selected, a user may view the recipe and directions associated therewith, if any, and select the ingredients needed in the recipe. For example, if the recipe was for turkey dressing as discussed above and it called for salt, the user may not need salt because they already have some in the house. Thus, the user may deselect salt from the recipe list. At any point in the process, the recipe may be turned into a shopping list. In some embodiments, this shopping list may be used to populate a virtual shopping cart as illustrated in FIG. 2D. However, the shopping list may also be printed to enhance in store shopping. In some embodiments, when the shopping list is populated, i.e. upon entering a recipe, users may be prompted with a choice to add complementary items to the shopping list. For example, if the user has populated the shopping list with a recipe for dinner, side items such as starches and vegetables may be suggested. Complimentary desserts or even unrelated items such as paper towels may also be suggested in some embodiments. In further embodiments, where the recipe does not relate to food, for example, a clothing recipe, items that could possibly change a daytime outfit to evening outfit could be suggested.

It will be understood that users may make substitutions in the recipe for a variety of reasons beyond the items they already have in the home. For example, users may have allergies to certain items, may be on a specific diet related to a medical condition, may be on a weight reducing or gaining diet and the like. If the user is a subscriber, discussed further below, then these factors may be included in the user's profile and these things will be automatically accounted for when populating the user's shopping list.

As will be discussed further herein, in some embodiments, the shopping list may be sent to various area stores and the pricing information associated with the items in on the shopping list may be provided to the user for each store. For example, there may be five stores within a particular radius of the user and each store will present the price for the particular items in on the shopping list. The user can then select the particular store. In some embodiments, the user can also have these items delivered to their location, may use the shopping list to obtain the items at the store or have the items ready for pick up at the store.

Furthermore, it will be understood that users can be “guest” users or “subscribers.” A guest user may use services associated with embodiments of the present inventive concept randomly and no information may be maintained with respect to the guest users. Subscribers may have an account with the service. Subscribers may provide information related to types of foods, brands, pricing and the like particular to the subscriber. Thus, in accordance with some embodiments of the present invention, this information may be used to populate the subscribers shopping list from the “recipe” without having to prompt the subscriber with respect to brand and pricing options. For example, the subscriber may indicate in his or her profile that store brands should always be selected. Thus, when populating the shopping list, only store brands will be selected when available. A subscriber can change his or her settings as often as needed and can change them temporarily for any one purchase without changing the overall settings.

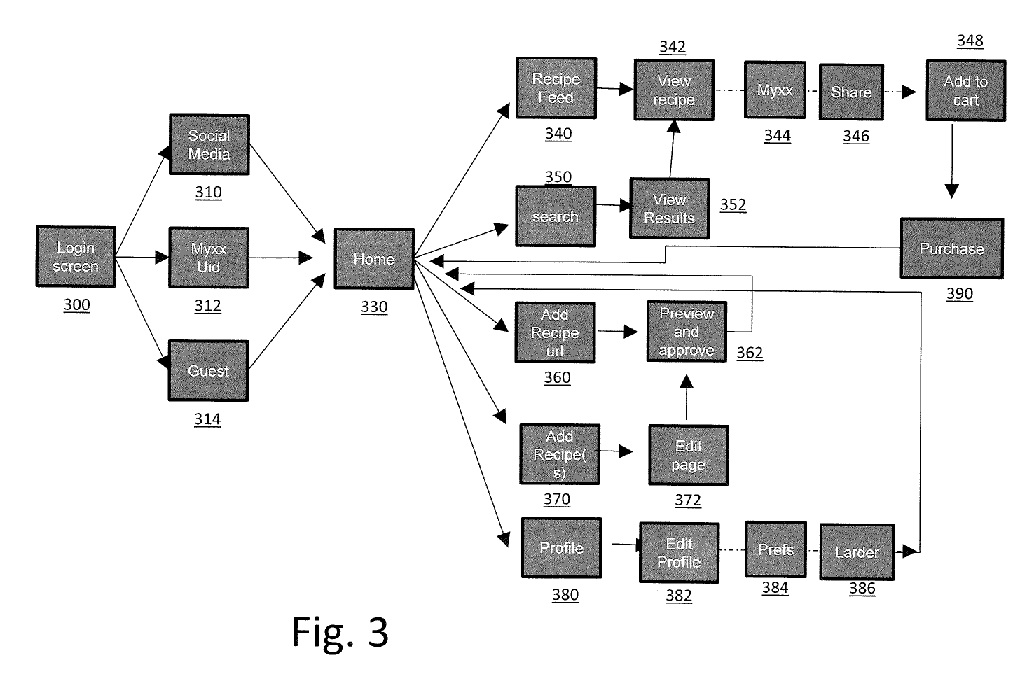

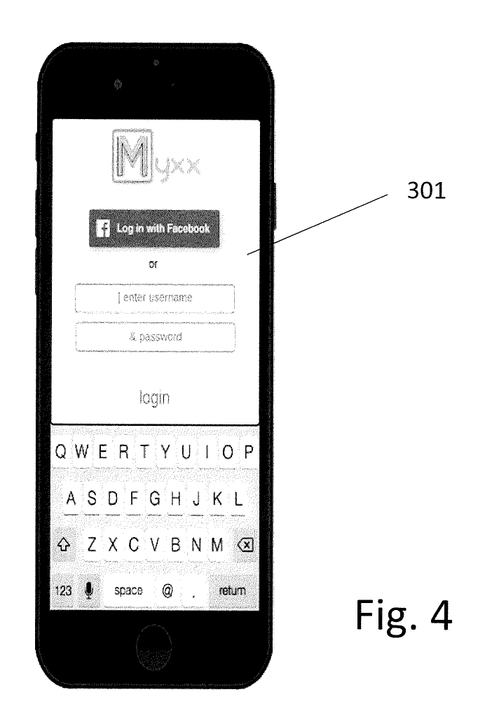

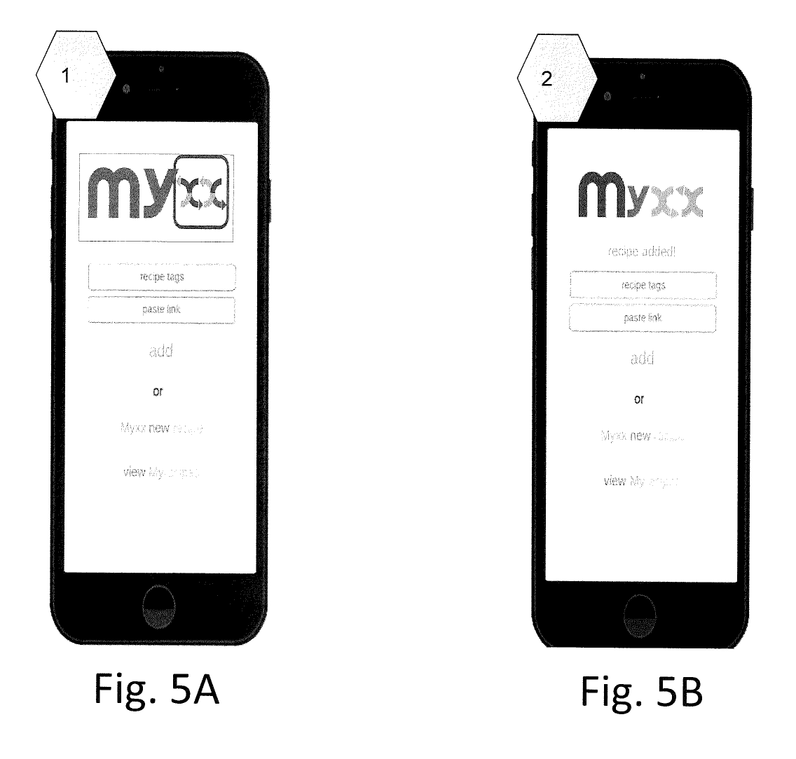

Referring now to FIG. 3, a detailed flow diagram illustrating operations in accordance with various embodiments of the present inventive concept will be discussed. As illustrated in FIG. 3, operations begin by presenting users a login screen (block 300), for example, the login screen 301 illustrated in FIG. 4. As illustrated therein, a subscriber may login with their Myxx user name/ID and password (block 312); using a social media membership (block 310) for example, facebook; or as a guest (block 314). Once logged in (blocks 300-314), the user may be presented with a home screen (block 330). Example home screens are provided in FIGS. 5A and 5B. As illustrated, the user has various options from the home screen. The user may add a recipe (FIG. 5A) or access a recipe that has been added (FIG. 5B). In other words, in some embodiments when a recipe is added through URL Paste (block 360), upon entering in the URL embodiments of the present invention will automatically ingest all the needed information from the recipe (FIG. 5A) or the user will receive an email once recipe is ready (FIG. 5B). The recipe may then be previewed and approved (block 362) before it is saved. From the home screen the user may also modify (block 372) (Myxx) a new recipe or access recipes stored in their account (My Recipes). In further embodiments, a notification may be provided to the user in the application via modal notification. The recipe feed screen may be used as the home screen and may allow users to add a recipe through expansion of the search field, or with a modal/overlay. Thus, from the home screen, users can add a recipe, navigate the recipe and modify/edit the recipe, search through recipes and the like. Users may also view and edit their profile (blocks 380 and 382). The profile (block 380) may include, for example, a user's name, photograph, preferences (block 384), followers and list of users the user is following, larder (a virtual cupboard or pantry for storing things) (block 386) and the like. Furthermore, a user may be able to upload preferences from another account in some embodiments.

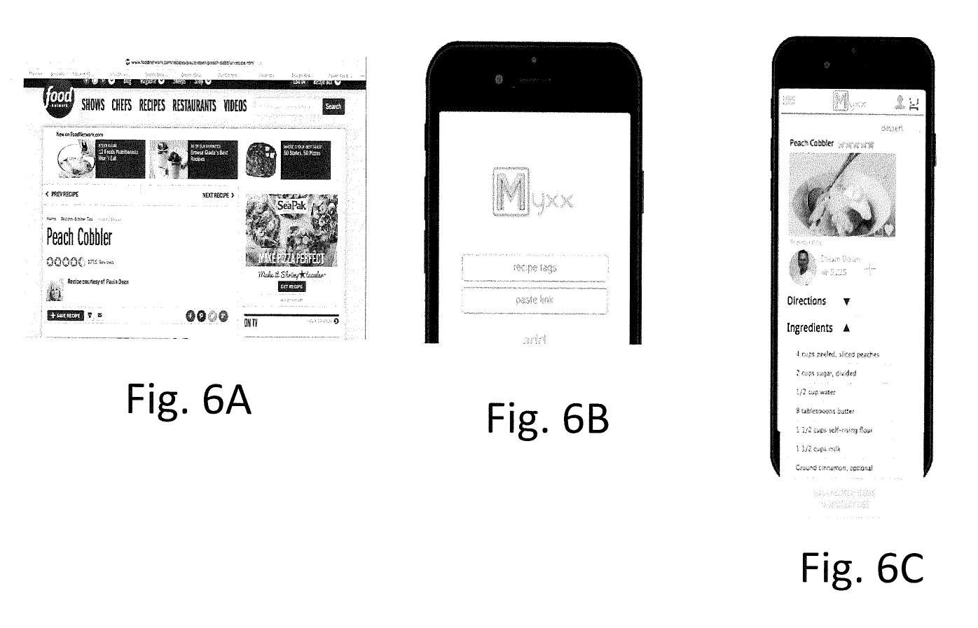

Referring now to FIGS. 6A through 6C, a user may find a recipe he or she is interested in, for example, a peach cobbler recipe as illustrated in FIG. 6A. A link to the recipe may then be pasted into Myxx as illustrated in FIG. 6B. The recipe is loaded (added block 370) into Myxx in the format needed to perform functions in accordance with some embodiments of the present inventive concept as illustrated in FIG. 6C.

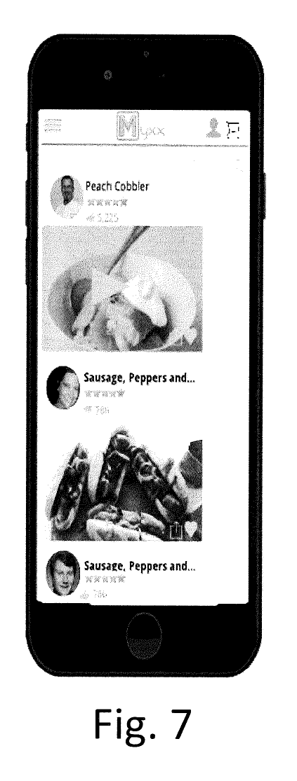

Referring again to FIG. 3, operations of the recipe feed (blocks 340-348) will be discussed. In the recipe feed (block 340), users can view the recipe (block 342), Myxx the recipe (block 344), share the recipe (block 346) and add the final recipe to the shopping list/cart (block 348) to be printed or purchased (block 390). A screen shot of the recipe feed 340 is illustrated, for example, in FIG. 7. Information that may be available includes, for example, the Chef's name and photo; recipe title; rating, for example, a number of stars indicating a rating, which comes from the community; a number of views, i.e. how many times the recipe has been viewed; a video related to preparation of the recipe and the like.

Furthermore, recipes may be searched by, for example, title and/or ingredients. In some embodiment, results of a search may be filtered, for example, results may be filtered by type of meal, i.e. breakfast, lunch, snack, dinner, desert or based on preferences and/or allergies. Once a recipe is obtained and myxxed, the recipes can be saved/uploaded in a recipe folder associated with a user's accounts (My Recipes). Users may also have access to a recipe feed including the most popular recipes (trending recipes) and the like.

As discussed above, in some embodiments the user may provide, store, modify (block 372) etc. preferences that can be used by embodiments discussed herein to, for example, select a particular brand of product, avoid particular allergies or foods that are disliked etc. In some embodiments, users may have different classification, for example, there may be a general class of user and a contributor class, i.e. someone who both uses recipes and contributes their own. In some embodiments, icons may indicate various things about the recipe, for example, the difficulty of making the recipe may be indicated by an icon of a myxxing bowl where the color of the bowl indicates the difficultly of the recipe. Other features that may be available according to some embodiments of the present inventive concept are user ratings for the particular content, an indication of lineage for the recipe, i.e. how many times has the recipe been changed (myxxed) and recipes that have been myxxed may have a different background or border.

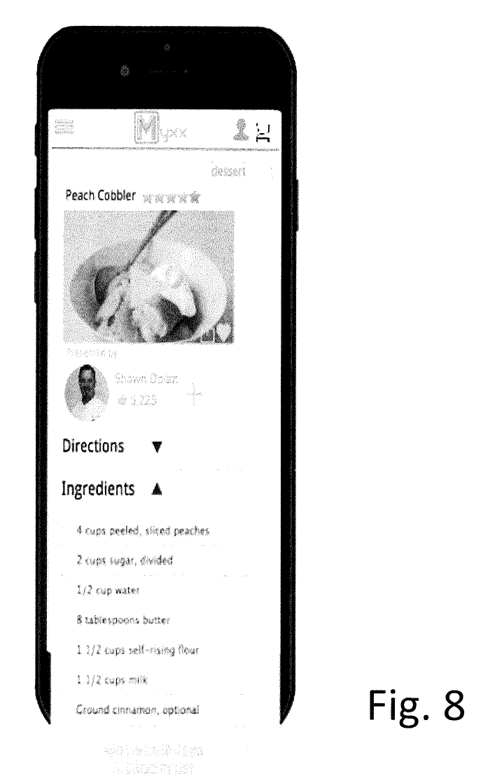

Referring now to FIG. 8, an example screen shot illustrating viewing a recipe will be discussed. As illustrated therein, the screen may include a recipe title; the number of stars associated therewith (user input); photos of the completed recipe as well as intermediate steps thereof; a photo of the Chef associated with the particular recipe; a name of the Chef associated with the particular recipe; directions associated with the recipe; the ingredients; tags and the like. These items are provided for example only and, therefore, are not limited to the listing discussed. For example, the pictures may also include pictures of the completed recipe or intermediate steps thereof uploaded by users who have tried the recipe without departing from the scope of the present inventive concept.

In some embodiments, the recipe may be associated with a particular brand. For example, an advertisement for a particular brand of eggs may be associated with the recipe. When the recipe is selected, the user is transported to a “branded landing page” for that advertised brand. The branded landing page includes all the details of the recipes selected and the shopping list is populated in accordance with embodiments discussed herein. However, the “brand” associated with the branded landing page is placed on the shopping list if the product is offered in that particular brand. For example, the eggs placed on the shopping list would be the eggs advertised.

In some embodiments, the user is able to Myxx the recipe, for example, change items in the list of ingredients or change quantities thereof. For example, a user may swap out an item on the list for something else or substitute an item on the list with something else. If the user does Myxx the recipe, the recipe may have an indication of lineage, i.e. how many times the recipe has changed over time. As discussed above, photos of the various versions may be available to a user.

In some embodiments of the present inventive concept, once the user has finalized the list of ingredients, the ingredients (all or subset) may be added to a shopping list and embodiments of the present inventive concept may automatically convert the items needed for the recipe into specific quantities so the user does not have to do so. Details of the recipe, for example, directions and/or ingredients, may be “hidden” so they are not visible on the screen.

In some embodiments, users, chefs and the like may have followers and may follow others. Notifications may be provided to a follower, for example, a notification may be provided if a new recipe has been provided by users/chefs you follow.

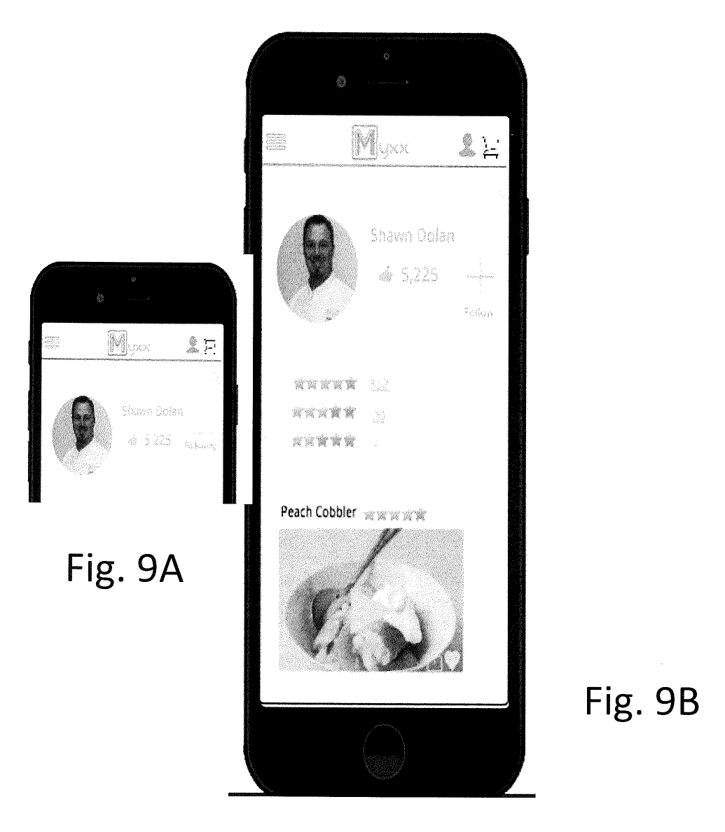

Referring now to FIGS. 9Aa and 9B, some embodiments of the present inventive concept may include profiles on the particular chefs. For example, the profile may include, the chef's name and photo; a description of the chef and his resume, which may be limited to a particular number of characters; indications of “likes” associated with the chef; a list of all recipes by the chef and myxxed versions thereof and the like. In some embodiments, “likes” may be differentiated, for example, men, women, kids, age demographics etc. For example, a kid rating may include, for example, a “mikey likes it” barometer or something similar thereto.

In further embodiments, a chef may also be a partner retailer whereby the recipes are associated with a particular retailer. These may also vary depending upon weekly specials, and can be seeded with products at the request of the retailer.

In some embodiments, the chef may have followers who may receive notifications of the chef's activity, for example, new recipes, new myxxes of recipes, videos, pictures and the like. User's may share recipes and may be able to view recipes by associated star ratings. Some embodiments may also include rankings for the particular chef and how this chef ranks with respect to other chefs and the like.

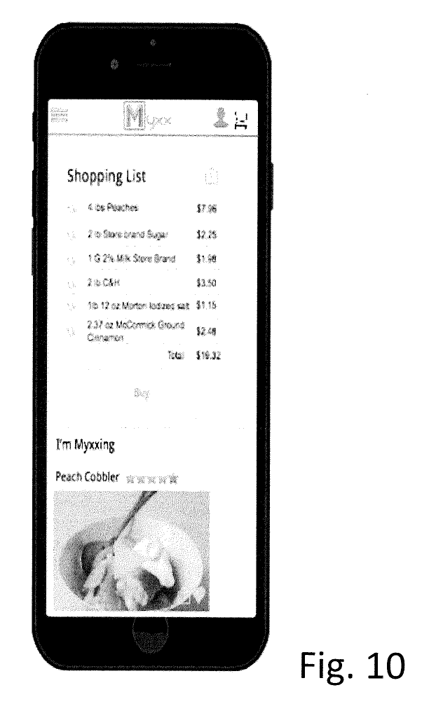

Referring now to FIG. 10, a screen shot including an example shopping list will be discussed. As illustrated therein, the shopping list may include a list of ingredients from all recipes. In some embodiments, users have the ability to check and uncheck ingredients on the shopping list, i.e. remove particular items that would have been part of the original recipe. The shopping list may include a list of all recipes selected and users may share the list, for example, by email.

In some embodiments, the shopping list includes a “My Meals” surface including selected recipes on a shopping list. When a recipe is removed all associated ingredients may also be removed and when all ingredients are removed the recipe may be removed. In some embodiments of the present inventive concept, the ingredients from two recipes may be combined. For example, if one recipe calls for ½ cup flour, and another 1.5 cups of flour then the list would include 2 cups total. Thus, some embodiments place the product size needed for the particular recipe(s) on the shopping list.

As discussed above, a user may have a profile that indicates various preferences, thus, the shopping list may include brands preferred by the user, ingredients may be substituted for other ingredients based on the user's profile, and the like. In some embodiments, the list may be printed for use in the store or exported to, for example, facebook, text, ios, third parties, mywebgrocer and the like. In some embodiments, the list may be shared with various grocery stores and each store may present a total cost of the items on the shopping list. The user may then choose where to purchase the groceries and pick them up. In some embodiments, once purchased the items on the shopping list may be delivered to the user. However, in some embodiments, the user may choose to simply print the shopping list and obtain the groceries offline in the store.

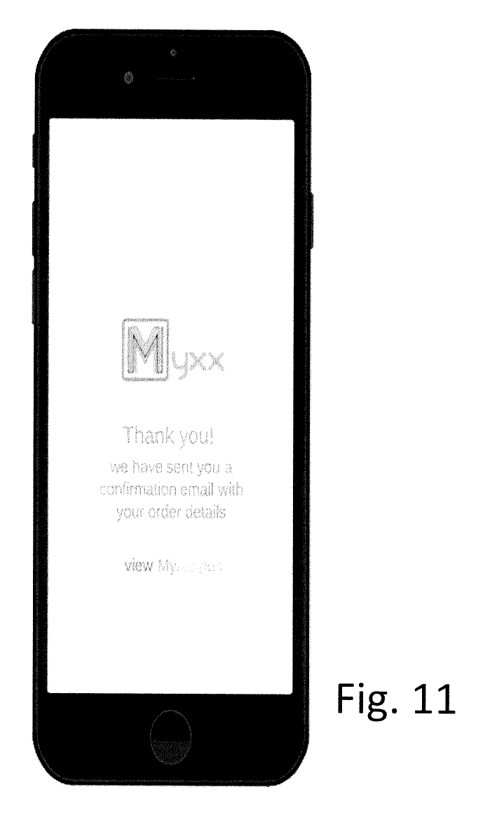

Referring now to FIG. 11, an example “thank you” screen will be discussed. As illustrated in FIG. 11, once the items in the car are purchased a thank you screen may be displayed. A confirmation email may be sent. In some embodiments, the list may be sent back to recipe feed; the virtual pantry may be updated with the purchased items; an estimated delivery time may be provided with a real time map (if being delivered); and the like. It will be understood that embodiments of the present inventive concept are not limited to this configuration. For example, a “thank you” may be communicated to a user by notification modal without departing from the scope of the present inventive concept.

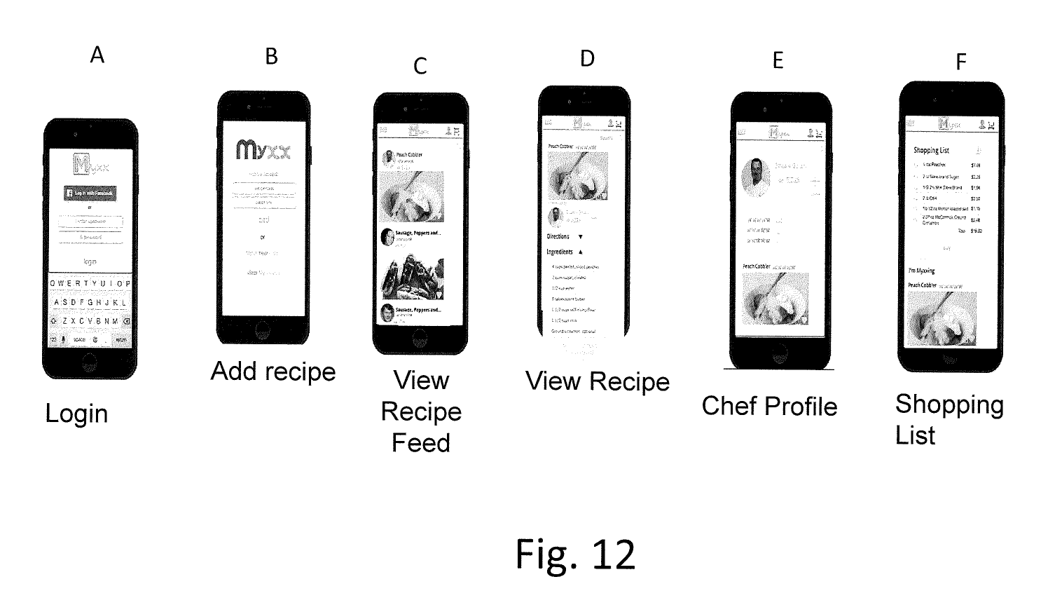

Referring now to FIGS. 12A through 12F, a summary of the various screens will now be discussed. The screens may include a login screen (FIG. 12A); a screen for adding a recipe (FIG. 12B); a screen for viewing the recipe feed (FIG. 12C); a screen for viewing the recipe (FIG. 12D); a Chef profile screen (FIG. 12E) and a shopping listcartcarycreen (FIG. 12F). It will be understood that embodiments of the present inventive concept are not limited to these examples and, therefore, more or less screens may be provided without departing from the scope of the present inventive concept.

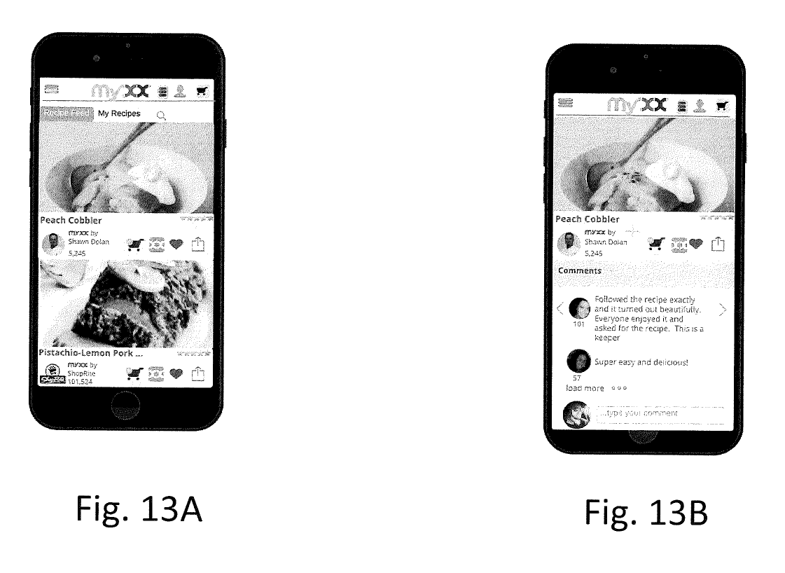

Referring now to FIGS. 13A and 13B, in some embodiments, the users may have the ability for social sharing recipes on other platforms. Communications from other platforms, for example, facebook, twitter, pinterest and the like, may be combined with embodiments of the present inventive concept. Thus, users may be able to track what recipes people in their “social network” are liking, commenting on, tweeting, providing pictures of and the like. A comments screen may be provided on the various screens, for example, the ingredients, directions, comments flow, recipe feed and the like as illustrated in FIGS. 13A and 13B.

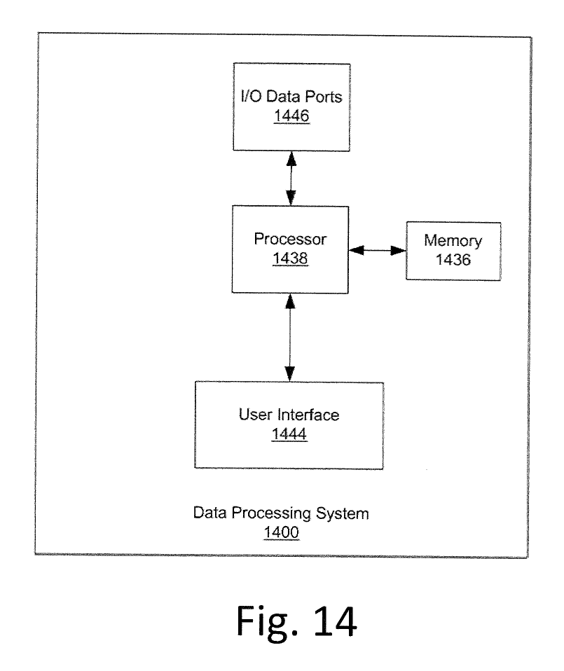

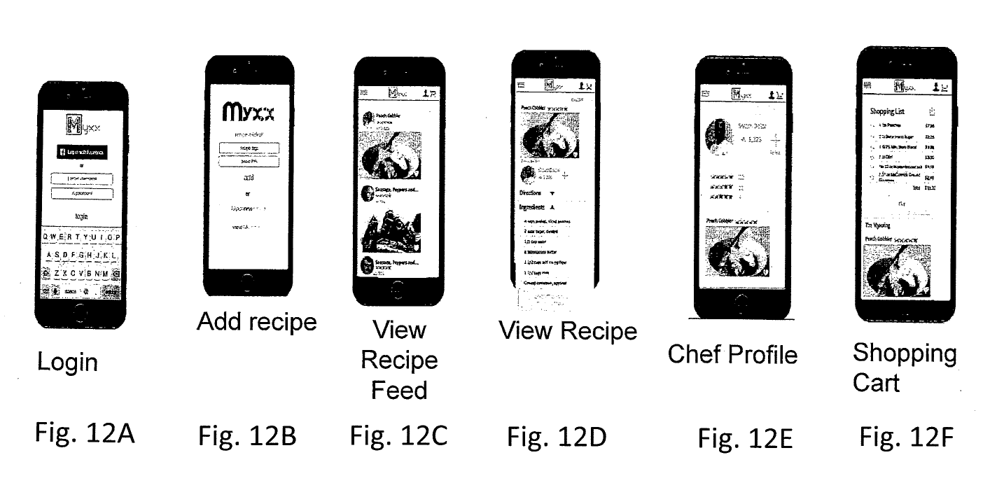

Referring now to FIG. 14, an exemplary embodiment of a data processing system 1400 suitable for use in the systems according to some embodiments of the present inventive concept will be discussed. For example, the data processing system may be included in a server according to some embodiments of the present inventive concept. As illustrated in FIG. 14, the data processing system includes a user interface 1444 such as a display, a keyboard, keypad, touchpad or the like, I/O data ports 1446 and a memory 1436 that communicates with a processor 1438. The I/O data ports 1446 can be used to transfer information between the data processing system 1400 and another computer system or a network. These components may be conventional components, such as those used in many conventional data processing systems, which may be configured to operate as described herein. This data processing system 1400 may be included any type of computing device without departing from the scope of the present inventive concept. For example, the computing device may be mobile device, such as a smart phone, a tablet and the like, or a desk top device.

As discussed above, embodiments of the present inventive concept allow people to find, modify, share, purchase and like “recipes” in a unique way. In embodiments where the recipe is related to food, embodiments may be combined with a camera in a “smart fridge” positioned in users home, which would be configured to communicate with embodiments of the present inventive concept to provide information related the needs of a user. In further embodiments, concepts discussed herein may be used in combination with smart homes and may communicate grocery needs or turn on an appliance automatically without user intervention. For example, a home automation device, such as “Alexa” can be used to create a shopping list using only ones voice and this list may be used in combination with embodiments discussed herein.

Example embodiments are described above with reference to block diagrams and/or flowchart illustrations of methods, devices, systems and/or computer program products. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the functions/acts specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, example embodiments may be implemented in hardware and/or in software (including firmware, resident software, micro-code, etc.). Furthermore, example embodiments may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of data processing systems discussed herein may be written in a high-level programming language, such as Java, AJAX (Asynchronous JavaScript), C, and/or C++, for development convenience. In addition, computer program code for carrying out operations of example embodiments may also be written in other programming languages, such as, but not limited to, interpreted languages. Some modules or routines may be written in assembly language or even micro-code to enhance performance and/or memory usage. However, embodiments are not limited to a particular programming language. It will be further appreciated that the functionality of any or all of the program modules may also be implemented using discrete hardware components, one or more application specific integrated circuits (ASICs), or a field programmable gate array (FPGA), or a programmed digital signal processor, a programmed logic controller (PLC), microcontroller or graphics processing unit.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

In the drawings and specification, there have been disclosed exemplary embodiments of the inventive concept. However, many variations and modifications can be made to these embodiments without substantially departing from the principles of the present inventive concept. Accordingly, although specific terms are used, they are used in a generic and descriptive sense only and not for purposes of limitation, the scope of the inventive concept being defined by the following claims.

That which is claimed is:

1. A method of providing a recipe service, the method being associated with a server including a processor therein, the processor being configured to:
receive input from a user, the input being associated with a recipe;
customize a list of items defining the recipe based on parameters associated with the user and/or input received from the user in real time;
automatically populate a shopping list with the customized list of items defining the recipe for purchase by the user;
modify the shopping list responsive to user input; and
provide the modified shopping list for use by the user to purchase the items on the modified shopping list.

2. The method of claim 1, wherein the processor is further configured to:
provide a cost associated with the modified shopping list for each of a plurality of different providers of the items on the modified shopping list; and
receive a selection of one of the plurality of different providers of the items from the user before purchase of the items on the modified shopping list by the user.

3. The method of claim 1, wherein the processor is further configured to:
receive one of a purchase command from the user indicating that the user wants to purchase all the items on the modified shopping list and a print command from the user indicating that the user wants to print the modified shopping list; and
if the purchase command is received, schedule the purchased list of items for one of delivery to the user and pick up by the user.

4. The method of claim 3, wherein the processor is further configured to provide at least one of an estimated delivery time associated with the purchased list of items and a real time map of a current position of the purchased list of items.

5. The method of claim 3, wherein the processor is further configured to share one of the recipe; the modified shopping list; a picture of a completed recipe and a reaction to the recipe on a social media platform.

6. The method of claim 1, wherein the recipe is associated with one of food, interior design, beverages, alcoholic beverages and clothing ensembles.

7. The method of claim 1, wherein the user is one of a subscriber of a recipe service and a guest of the recipe service.

8. The method of claim 7, wherein when the user is a subscriber of the recipe service, the processor is further configured to receive and store preferences associated with the subscriber based on at least one of cost; brand; allergies and taste.

9. The method of claim 7, wherein when the user is a subscriber the processor is further configured to store the modified shopping list in a virtual pantry associated with the subscriber and automatically update the pantry as items are purchased or responsive to input by the subscriber.

10. The method of claim 1, wherein the processor is further configured to modify the shopping list by at least one of adding items to the list; deleting items from the list; changing brands of items on the list and selecting a similar item that is priced differently than the item on the list.

11. The method of claim 1, wherein the processor is further configured to prompt the user with options to add additional items to the shopping list.

12. The method of claim 1, wherein the processor is further configured to provide a reward to a partner associated with the recipe responsive to the input associated with the recipe from the user.

13. The method of claim 1, wherein the processor is further configured to provide an indication of difficulty of the recipe by altering an icon on a display associated with the server.

14. The method of claim 1, wherein the processor is configured to receive input from the user associated with a recipe by one of receiving a link to a recipe located on a server remote from the server including the processor and receiving a selection of a recipe located on the server including the processor.

15. A server for hosting a recipe service, the server comprising a processor configured to:
receive input from a user, the input being associated with a recipe;
customize a list of items defining the recipe based on parameters associated with the user and/or input received from the user in real time;
automatically populate a shopping list with the customized list of items defining the recipe for purchase by the user;
modify the shopping list responsive to user input; and
provide the modified shopping list for use by the user to purchase the items on the modified shopping list.

16. The server of claim 15, wherein the processor is further configured to:
provide a cost associated with items on the modified shopping list for each of a plurality of different providers of the items; and
receive a selection of one of the plurality of different providers of the items from the user before purchase of the items on the modified shopping list by the user.

17. The server of claim 15, wherein the processor is further configured to:
receive one of a purchase command from the user indicating that the user wants to purchase all the items on the modified shopping list and a print command from the user indicating that the user wants to print the modified shopping list; and
schedule the purchased list of items for one of delivery to the user and pick up by the user if the purchase command is received.

18. A computer program product for providing a recipe service, the computer program product comprising:
a non-transitory computer readable storage medium having computer readable program code embodied therein, the computer readable program code comprising:
computer readable program code for receiving input from a user, the input being associated with a recipe;
computer readable program code for customizing a list of items defining the recipe based on parameters associated with the user and/or input received from the user in real time;
computer readable program code for automatically populating a shopping list with the customized list of items defining the recipe for purchase by the user;
computer readable program code for modifying the shopping list responsive to user input; and
computer readable program code for providing the modified shopping list for use by the user to purchase the items on the modified shopping list.

19. The computer program product of claim 18, further comprising:
computer readable program code for providing a cost associated with the items on the modified shopping for each of a plurality of different providers of the items; and
computer readable program code for receiving a selection of one of the plurality of different providers of the items from the user before purchase of the items on the modified shopping list by the user.

20. The computer program product of claim 18, further comprising:
computer readable program code for receiving one of a purchase command from the user indicating that the user wants to purchase all the items on the modified shopping list and a print command from the user indicating that the user wants to print the modified shopping list; and
computer readable program code for scheduling the purchased list of items for one of delivery to the user and pick up by the user if the purchase command is received.
